(19) United States
(12) Patent Application Publication
(10) Pub. No.: US 2022/0222528 A1
(43) Pub. Date: Jul. 14, 2022

(54) Method for Making a Neural Network More Robust in a Function-Specific Manner

(71) Applicant: Volkswagen Aktiengesellschaft, Wolfsburg (DE)

(72) Inventors: Nikhil Kapoor, Wolfsburg (DE); Peter Schlicht, Wolfsburg (DE); Nico Maurice Schmidt, Berlin (DE)

(73) Assignee: Volkswagen Aktiengesellschaft, Wolfsburg (DE)

(21) Appl. No.: 17/612,241

(22) PCT Filed: May 6, 2020
(86) PCT No.: PCT/EP2020/062638

§ 371 Date: Nov. 18, 2021

(30) Foreign Application Priority Data
May 23, 2019 (DE) 10 2019 207 573.8

(51) Int. Cl. G06N 3/08; G06N 3/04

(52) U.S. Cl. CPC G06N 3/08; G06N 3/04

(57) ABSTRACT

The invention relates to a method for making a neural network more robust in a function-specific manner, comprising the following steps: providing the neural network, wherein the neural network is/has been trained on the basis of a training data set including training data; generating at least one changed training data set by manipulating the training data set, wherein the training data is changed while maintaining semantically meaningful content; changing parameters and/or an architecture of the neural network according to a comparison result of a comparison between an application of the original training data set and the at least one changed training data set on the trained neural network; training the changed neural network on the basis of the training data set and at least one part of the at least one changed training data set. The invention also relates to a device, to a computer program product, and to a computer-readable storage medium.

### CROSS-REFERENCE TO RELATED APPLICATIONS

This application claims priority to German Patent Application No. DE 10 2019 207 573.8, filed on May 23, 2019 with the German Patent and Trademark Office. The contents of the aforesaid patent application are incorporated herein for all purposes.

### TECHNICAL FIELD

The invention relates to a method for making a neural network more robust in a function-specific manner. The invention also relates to a device for data processing, to a computer program product, and to a computer-readable storage medium.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Machine learning, for example on the basis of neural networks, has great potential for an application in modern driver assistance systems and automated motor vehicles. In this case, functions based on deep neural networks process raw sensor data (by way of example, from cameras, radar or lidar sensors) in order to derive relevant information therefrom. This information includes, by way of example, a type and a position of objects in an environment of the motor vehicle, a behavior of the objects or a road geometry or topology. Among the neural networks, convolutional neural networks have proven to be particularly suitable for applications in image processing. However, while these neural networks outperform classic approaches in terms of functional accuracy, they also have disadvantages. Thus, interference in captured sensor data or attacks based on adversarial interference can, for example, result in a misclassification or incorrect semantic segmentation taking place despite semantically unchanged content in the captured sensor data. Attempts are therefore being made to make neural networks robust against this type of interference.

However, making neural networks more robust is at present only unsatisfactorily solved.

### SUMMARY

A need exists for making a neural network more robust in a function-specific manner.

The need is addressed by a method, a computer program, and a device having the features the independent claims. Embodiments of the invention are described in the dependent claims, the following description, and the drawings.

### BRIEF DESCRIPTION OF THE DRAWINGS

FIG. 1 shows a schematic representation of an embodiment of a device for data processing;

FIG. 2 shows a schematic flow chart of an embodiment of a method for making a neural network more robust in a function-specific manner;

FIG. 3 shows a schematic block diagram of an embodiment of a method for making a neural network more robust in a function-specific manner;

FIG. 4 shows a schematic representation of activation differentials determined in each case for individual filters of a convolutional neural network; and

FIG. 5 shows a schematic and exemplary representation of activation differentials determined in each case for individual filters of a convolutional neural network according to different manipulation methods.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for making a neural network more robust in a function-specific manner is made available, comprising the following steps:
a) providing the neural network, wherein the neural network is/has been trained on the basis of a training data set including training data;
b) generating at least one changed training data set by manipulating the training data set, wherein the training data is changed while maintaining semantically meaningful content;
c) changing parameters and/or an architecture of the neural network according to a comparison between an application of the original training data set and the at least one changed training data set on the trained neural network;
d) training the changed neural network on the basis of the training data set and at least one part of the at least one changed training data set.

In a further exemplary aspect, a device for data processing is provided, comprising means for executing the steps of the method according to any one of the described embodiments.

A computer program is further provided, comprising commands which, when the computer program is run by a computer, prompt the latter to execute the steps of the method according to any one of the described embodiments.

A computer-readable storage medium is also provided, comprising commands which, when run by a computer, prompt the latter to execute the steps of the method according to any one of the described embodiments.

The method and the device make it possible to increase a robustness of a neural network, in particular of a convolutional neural network, with respect to interference. To this end, a training data set, with which the neural network is/has been trained, is changed. In this case, the changes made to the training data set do not change semantically meaningful content, but merely semantically insignificant content. In this case, semantically meaningful content denotes in particular a semantic context which is important for a function of the trained neural network. The semantically meaningful content is in particular the content which the function of the trained neural network is intended to recognize as part of a semantic segmentation or classification. In contrast to this, the semantically insignificant content is in particular content which may ideally be designed as desired without impairing a function of the trained neural network as a result. A thus changed training data set and the original training data set are subsequently applied to the trained neural network, that is to say the training data and the changed training data are in each case supplied to the trained neural network as input data. The neural network is subsequently changed according to a comparison result of a comparison between the application of the original training data set and the at least one changed training data set on the trained neural network. The change is made by changing parameters of the neural network and/or by changing an architecture or structure of the neural network. This creates a neural network that has changed its parameters and/or its architecture or structure. The changed neural network is subsequently trained on the basis of the training data set and at least one part of the at least one changed training data set. The trained changed neural network is subsequently provided.

A benefit of the method is that a robustness of a neural network with respect to disturbed input data may be improved, since parameters and/or an architecture or structure of the neural network is/are changed according to a comparison result of a comparison between an application of the original training data set and the at least one changed (i.e., disturbed) training data set on the trained neural network.

A neural network is in particular an artificial neural network, in particular a convolutional neural network. The neural network is in particular trained for a certain function, for example a perception of pedestrians in captured camera images.

The training data of the training data set may be configured to be one-dimensional or multi-dimensional, wherein the training data is marked (“labeled”) in terms of semantically meaningful content. For example, the training data may be captured camera images which are marked in terms of semantically meaningful content (e.g., pedestrians).

In order to change the training data of the training data set, various manipulation methods may be deployed. In this case, it is in particular provided that semantically meaningful content of the training data is not changed. This means in particular that only non-relevant context dimensions are changed. If the neural network is trained, for example, to recognize pedestrians in captured camera images, camera images used as training data are changed, when changes are made, in such a way that one or more pedestrians present in a captured camera image are not changed or are only changed in an irrelevant manner. In the example of the camera images, the following manipulation methods may be used, for example: photometric manipulation methods (e.g., a change in brightness, contrast, saturation), noise and blurring (e.g., Gaussian blur, Gaussian noise, salt-and-pepper noise) or adversarial manipulation methods (e.g., “Fast Gradient Sign Method”). More complex methods may also be applied as manipulation methods; for example, it may be provided that a summer scene is altered to a winter scene without semantically meaningful content (e.g., a depicted pedestrian) itself being removed. Furthermore, colors, textures or other properties of objects and/or surfaces of the objects can, for example, be changed; for example. A color of a motor vehicle can, for example, be changed or a reflection behavior of a surface of the motor vehicle. In particular, the following manipulations may be carried out individually or in combination with one another: added sensor noise in the training data, contrast, brightness and/or image sharpness shifts, hue shifts, color intensity shifts, color depth shifts, color changes of individual (semantic) objects, small changes to objects (e.g., dirt, a deflection, a reflection on the object, meteorological effects, stickers or graffiti on the object), a rotation and/or a shift and/or distortions in the training data, a change in the physical properties of objects (e.g., the reflection properties or the paint properties of a motor vehicle, etc.).

In order to change the parameters of the neural network and/or the architecture or structure of the neural network, the following methods may in particular be used:
Changing a quantization resolution used in the neural network (e.g., by changing a data type used);
Pruning (simplifying, shortening and optimizing parts of the neural network, for example by removing individual neurons or regions of the neural network which react in a particularly sensitive manner to the changed training data);
Changing the weights in the neural network (changing the numerical values of the weights);
Changing metaparameters (e.g., parameters of convolution layers and activation functions).

In particular, the method is executed by means of a computing apparatus which may access a memory. The computing apparatus may be configured as a combination of hardware and software, for example as program code which is run on a microcontroller or microprocessor.

In some embodiments, it is provided that the steps c) and d) are repeated until such time as at least one termination criterion is met. As a result, an iterative optimization or maximization of the robustness may be achieved.

In some embodiments, it is provided that a robustness measure is determined for the neural network on the basis of the comparison, wherein the change is made on the basis of the determined robustness measure. For example, a real number, which makes it possible to assess the robustness and to compare a robustness of different neural networks with one another, may be assigned as a robustness measure.

In some embodiments, it is provided that the termination criterion is a convergence of the determined robustness measure. In this case, it is in particular checked whether the robustness measure converges towards a default value when iterations of the method are performed.

In some embodiments, it is provided that the termination criterion is reaching a target value for a functional quality of the trained changed neural network and/or reaching a target value for the determined robustness measure.

In some embodiments, it is provided that the parameters and/or the architecture or structure is/are changed separately by neurons and/or regions. It may be provided, for example, that only the neurons and/or regions of the neural network which react most sensitively to the changed training data are changed. This makes it possible to merely take account of particularly affected neurons and/or regions during the robustification, so that the effort involved in making changes may be reduced.

In some embodiments, it is provided that at least one activation differential between an activation of the neural network via the training data of the original training data set and an activation via the respective corresponding training data of the at least one changed training data set is determined during the comparison, wherein the change is made on the basis of the determined at least one activation differential. As a result, interference may be determined and analyzed in a particularly informative way. An activation is determined in particular on the basis of (inferred) values at the outputs of neurons of the neural network. In order to determine the activation differential, in particular the (inferred) values at the outputs of the neurons in the neural network are in each case compared with one another in pairs for the original and the changed training data.

In some embodiments, it is provided that activation differentials are determined and taken into account by neurons and/or regions. This makes it possible to identify neurons and/or regions of the neural network that are particularly affected by a manipulation of the training data or are sensitive. In particular, this makes it possible to analyze sensitive neurons and/or regions of the neural network in detail, so that these may for example be taken into account when the parameters and/or the architecture or structure of the neural network is/are subsequently changed. To this end, activation differentials are for example formed and provided in each case between the outputs of the neurons of the neural network, individually and/or in regions. It may for example be provided that an L2 distance (L2 standard) is formed between activation vectors which describe an activation of the neurons or regions. If the neural network is configured as a convolutional neural network, it may be provided, for example, that an activation differential is determined and provided for each filter in the convolutional neural network.

In some embodiments, it is provided that determined activation differentials are in each case taken into account averaged over multiple neurons and/or over a region. This makes it possible to analyze and evaluate the activation differentials or a sensitivity of the neural network more efficiently. For example, an average activation differential may be calculated for multiple neurons and/or regions. The averaging may take place in particular with the aid of statistical methods, for example an expected value may be determined for averaging. The subsequent change to the parameters and/or the architecture or structure of the neural network is then likewise made on the basis of the averaged activation differentials, that is to say, all neurons taken into account during the averaging or the entire region is/are changed together.

In some embodiments, it is provided that determined activation differentials are taken into account in a weighted manner according to a position of an associated neuron layer within the neural network. This makes it possible to take into account an influence which is to be expected on the outputs of the neural network since, as a rule, an increased sensitivity of a neuron layer in the vicinity of the input has a smaller influence on an end result supplied by the neural network than an increased sensitivity of a neuron layer in the vicinity of the output. If activation differentials of neurons and/or of regions of the neural network are averaged, the weighting may be taken into account when averaging in accordance with a position of the neuron layer in the neural network. The averaging may take place in particular with the aid of statistical methods; for example, an expected value may be determined for averaging.

In some embodiments, it is provided that determined activation differentials are in each case taken into account averaged over multiple inference runs. In this case, it may in particular be provided that the multiple inference runs are each performed for training data changed with different manipulation methods. As a result, activation differentials of individual neurons and/or activation differentials averaged over multiple neurons and/or over regions may also be averaged and taken into account over multiple types of interference. The averaging may take place in particular with the aid of statistical methods; for example, an expected value may be determined for averaging.

In some embodiments, it is provided that determined activation differentials are in each case taken into account in a weighted manner according to an associated manipulation method. For example, the respective activation differentials may be determined in each case for multiple manipulation methods for all neurons in the neural network and may each be weighted according to the associated manipulation method. This makes it possible to take all of the manipulation methods used into account when changing the neural network, whereby manipulation methods selected via the weights may be taken into account more strongly than others, that is to say, a striven-for robustness of the neural network may be prioritized in terms of one or more manipulation methods.

In some embodiments, it is provided that neurons and/or regions of the neural network are sorted according to the activation differentials determined in each case for these, wherein the change is made on the basis of an associated ranking. It may be provided, for example, that all of the (individual or averaged) activation differentials are sorted according to their amount and are provided in accordance with a ranking resulting from the sorting. This makes it possible to identify the most sensitively reacting regions, either averaged over all of the manipulation methods, or for individual manipulation methods. When the parameters and/or the architecture or structure of the neural network is/are subsequently changed, it may then be provided, for example, that merely the most sensitive, for example the top 5% or 10%, of the neurons or regions are changed, but that the remaining neural network is left unchanged.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

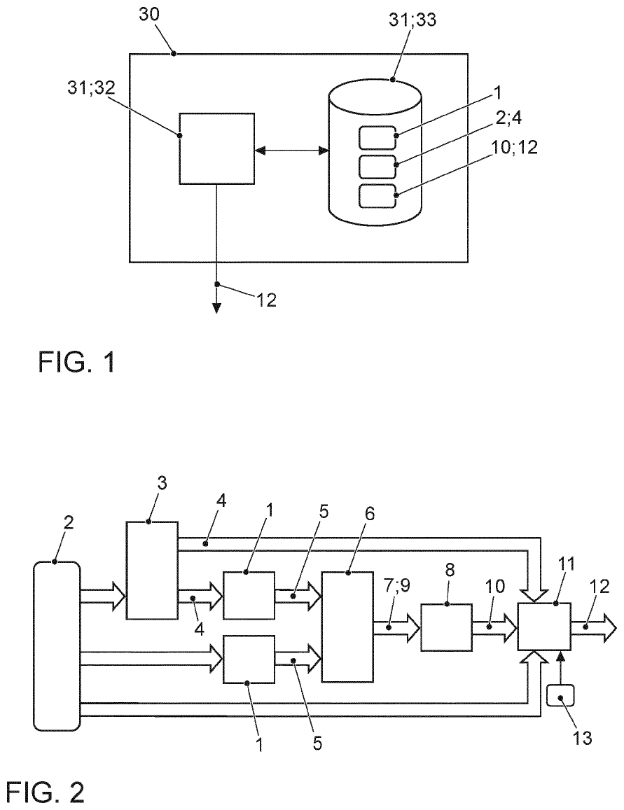

A schematic representation of a device 30 for executing the method is shown in FIG. 1. The device 30 comprises means 31 for executing the method. The means 31 comprise a computing apparatus 32 and a memory 33. In order to perform the method steps, the computing apparatus 32 may access the memory 33 and perform computing operations in the latter.

A neural network 1 and a training data set 2 are stored in the memory 33. The computing apparatus 32 generates at least one changed training data set 4 by manipulating the training data set 2, wherein the training data is changed while maintaining semantically meaningful content, wherein the at least one changed training data set 4 is also stored in the memory 33.

The computing apparatus 32 applies the training data set 2 and the changed training data set 4 to the neural network 1 by feeding the respective training data to the inputs of the neural network 1 and propagating said respective training data throughout the neural network 1. According to a comparison result of a comparison between an application of the original training data set 2 and the at least one changed training data set 4 on the trained neural network 1, the computing apparatus 32 changes parameters and/or an architecture or structure of the neural network 1. The changed neural network 10 is likewise stored in the memory 33. Following the change, the computing apparatus 32 trains the changed neural network 10 on the basis of the training data set 2 and at least one part of the at least one changed training data set 4. The trained changed neural network 12 is subsequently provided, for example in the form of a digital data packet which describes an architecture or structure and parameters and weightings of the trained changed neural network 12.

It may be provided that at least one activation differential between an activation of the neural network 1 via the training data of the original training data set 2 and an activation via the respective corresponding training data of the at least one changed training data set 4 is determined during the comparison, wherein the parameters and/or the architecture or structure of the neural network 1 is/are changed on the basis of the determined at least one activation differential.

A schematic flow chart for illustrating an embodiment of the method for making a neural network 1 more robust in a function-specific manner is shown in FIG. 2. In this case, the neural network 1 is already trained on the basis of a training data set 2.

At least one changed training data set 4 is generated by manipulating the training data set 2 by means of a manipulation method 3, wherein the training data contained in the training data set 2 is changed while maintaining semantically meaningful content.

The training data set 2 and the changed training data set 4 are each applied to the neural network 1, that is to say, they are each fed to the neural network 1 as input data, wherein the input data is propagated through the neural network 1 as part of a feed-forward sequence, so that inferred results may be provided at an output of the neural network 1.

If the training data is, for example, captured camera images, an undisturbed camera image of the original training data set 2 is supplied to the neural network 1. A manipulated or disturbed camera image from the changed training data set 4 is (subsequently) also fed to the neural network 1. In this case, activations 5 are in each case determined for individual neurons and/or regions of the neural network 1 and in each case compared with one another in pairs (undisturbed camera image/disturbed camera image), for example in a differential formation step 6. This differential formation step 6 supplies activation differentials 7 in each case for neurons and/or regions of the neural network 1 under consideration.

In a change step 8, parameters and/or an architecture or structure of the neural network 1 is/are changed. In this case, the change is made according to the determined activation differentials 7.

The neural network 10 changed in such a manner is subsequently trained in a training step 11 on the basis of the training data set 2 and at least one part of the at least one changed training data set 4 and is provided as a trained changed neural network 12.

In particular, it is provided that the parameters and/or the architecture or structure is/are changed separately by neurons and/or regions. In this case, it is provided that activation differentials 7 are accordingly determined and taken into account by neurons and/or regions.

It is provided that the change and the training of the changed neural network 10 are repeated until such time as at least one termination criterion 13 is met.

It may be provided that a robustness measure 9 is determined for the neural network 1 on the basis of the comparison, for example on the basis of the determined activation differentials 7, wherein the change is made on the basis of the determined robustness measure 9.

In an embodiment, it may then be provided that the termination criterion 13 is a convergence of the determined robustness measure 9.

It may also be provided that the termination criterion 13 is reaching a target value for a functional quality of the trained changed neural network 12 and/or reaching a target value for the determined robustness measure 9.

It may be provided that determined activation differentials 7 are in each case taken into account averaged over multiple neurons and/or over a region.

It may also be provided that determined activation differentials 7 are taken into account in a weighted manner according to a position of an associated neuron layer within the neural network 1.

It may be provided that determined activation differentials 7 are in each case taken into account averaged over multiple inference runs. In an embodiment, it may be provided that determined activation differentials 7 are in each case taken into account in a weighted manner according to an associated manipulation method 3.

It may also be provided that neurons and/or regions of the neural network 1 are sorted according to the activation differentials 7 determined in each case for these, wherein the change is made on the basis of an associated ranking. It may be provided, for example, that all of the (individual or averaged) activation differentials 7 are sorted according to their amount and are provided in accordance with a ranking resulting from the sorting. This makes it possible to identify the most sensitively reacting neurons and/or regions, either averaged over all of the manipulation methods 3, or for individual manipulation methods 3. When the parameters and/or the architecture or structure of the neural network 1 is/are subsequently changed, it may then be provided, for example, that merely the top 5% or 10% of the most sensitive neurons or regions are changed, but the remaining neural network 1 is left unchanged.

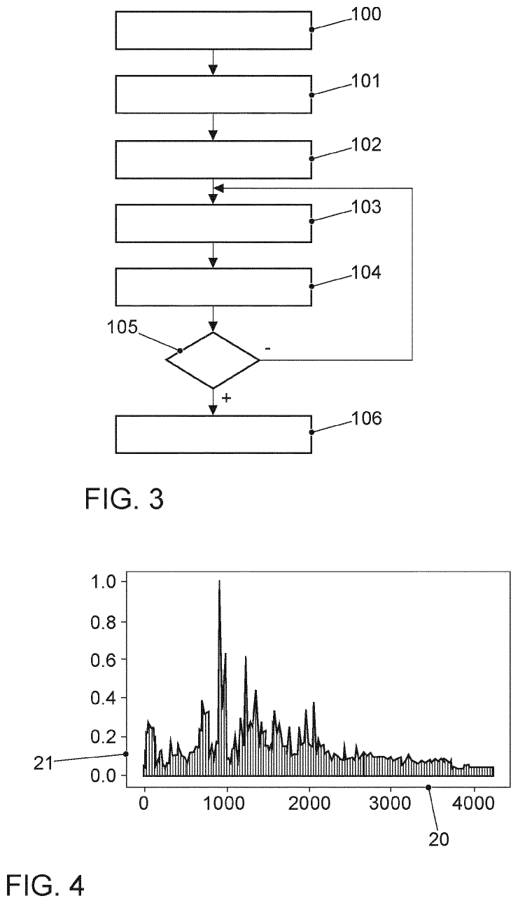

A schematic block diagram of an embodiment of the method for making a neural network more robust in a function-specific manner is shown in FIG. 3.

A neural network is provided in a method step 100. A structure and weightings of the neural network are stored, for example, in a memory of a computer. The neural network has either already been trained on the basis of a training data set including training data or is trained as part of method step 100 on the basis of the training data set. The neural network is trained, for example, to evaluate captured camera images and to ascertain whether a pedestrian is depicted in the camera images. The input data of the neural network is therefore two-dimensional camera images. The training data of the training data set is accordingly marked (“labeled”) camera images.

In a method step 101, multiple changed training data sets are generated by manipulating the training data set, wherein the training data is changed while maintaining semantically meaningful content (e.g., pedestrians in the camera images). To this end, the camera images which form the training data of the training data set are changed with the aid of manipulation methods.

In order to change the camera images, the following manipulations can, for example, be performed individually or in combination:
Adding noise in the camera images (e.g., Gaussian noise, salt-and-pepper noise);
Contrast and/or image sharpness shifts;
Hue shifts;
Color intensity shifts, color depth shifts;
Color changes to individual semantic objects (e.g., depicted motor vehicles, buildings, etc., in the camera images);
Adding contaminations to depicted objects (e.g., dirt, meteorological effects [rain, snow], stickers, graffiti, . . . );
Rotations, shifts and/or distortions of parts of the camera images;
Change of physical properties of depicted objects in the camera images (paint properties, reflection properties, . . . ).

In a method step 102, the training data of the training data set and respective associated changed training data of the changed training data set are fed to the neural network as input data, that is to say output data is inferred by means of the trained neural network on the basis of this input data. In this case, at least one activation differential between an activation of the neural network via the training data of the original training data set and an activation via the respective corresponding changed training data of the changed training data sets is determined.

The activation differential(s) may be determined both by averaging over neurons and over regions of the neural network.

In the case of a neural network configured as a convolutional neural network, it may for example be provided that activation differentials are determined for the individual filters of the convolutional neural network. A metric for determining the activation differentials of the individual filters is, for example, as follows:

$${d}_{i} = \hat{l} ( {f}_{i} ( x ) , {f}_{i} ( \hat{x} ) ) = \frac{1}{N} {\sum }_{n = 1}^{N} \frac{1}{{H}_{i} {W}_{i}} {\sum }_{w = 1}^{{W}_{i}} {\sum }_{h = 1}^{{H}_{i}} \vert \frac{{f}_{i , w , h} ( {x}_{n} ) - {f}_{i , w , h} ( {\hat{x}}_{n} )}{{f}_{i , w , h} ( {x}_{n} )} \vert \qquad$$

In this case, di is the activation differential of the filter having the index i, \hat{ }l(.,.) is an activation differential function, fᵢ(x) is an output function of the filter having the index i, Wᵢ×Hᵢ is a size of the output feature map of the filter having the index i, N is a number of images, xₙ is the original camera image (i.e., the original training datum), \hat{ }xₙ is the changed camera image (i.e., the changed training datum) and fᵢ(x) is an output function of the filter having the index i. In principle, however, another metric may also be used.

An exemplary result of activation differentials for each of the filters in one convolutional neural network is shown schematically in FIG. 4, wherein the x-axis 20 shows the index i of the filters in the convolutional neural network and the y-axis 21 shows a normalized activation differential. In this case, the activation differentials are normalized for a maximum activation differential. For the manipulation, a brightness in camera images of the training data set was changed, by way of example. It may be seen in this example that the convolutional neural network is configured to be particularly sensitive or less robust, in particular in the case of the filters around the filter index of 1000.

In a method step 103, parameters and/or an architecture of the neural network is/are changed according to the activation differentials determined in each case. In order to change the parameters of the neural network and/or the architecture or structure of the neural network, the following methods may be used in particular:
Changing a quantization resolution used in the neural network (e.g., by changing a data type used);
Pruning (simplifying, shortening and optimizing parts of the neural network, for example by removing individual neurons or regions of the neural network which react particularly sensitively to the changed training data);
Changing the weights in the neural network (changing the numerical values of the weights);
Changing metaparameters (e.g., hyperparameters of convolution layers and changing activation functions).

The changed neural network is subsequently trained on the basis of the training data set and at least one part of the at least one changed training data set in a method step 104.

In a method step 105 it is checked whether at least one termination criterion is met. The termination criterion can, for example, be a convergence of a determined robustness measure. Alternatively or additionally, the termination criterion may also be reaching a target value for a functional quality of the trained changed neural network and/or reaching a target value for the determined robustness measure.

If the termination criterion is met, the trained changed neural network is output in a method step 106, for example in the form of a digital data packet which describes the architecture or structure and parameters and weightings of the trained changed neural network.

If, on the other hand, the check in method step 105 reveals that the termination criterion is not met, method steps 103 and 104 are performed again, that is to say, the neural network is changed again and subsequently trained. In this way, a robustness of the neural network may be increased iteratively.

In method step 102, it may be provided that determined activation differentials are in each case averaged over multiple neurons and/or over a region, wherein the averaged activation differentials are provided in each case and are taken into account during changing in method step 103.

It may also be provided in method step 102 that determined activation differentials are provided in a weighted manner according to a position of an associated neuron layer within the neural network and are taken into account in method step 103 when changes are made. In particular, activation differentials of neurons or regions in neuron layers which are closer to the input of the neural network are weighted less heavily than activation differentials of neurons or regions in neuron layers which are closer to the output of the neural network. As a result, a greater influence may be given to a sensitivity of neuron layers which are closer to the output of the neural network during the assessment and increase in the robustness.

It may further be provided in method step 102 that activation differentials are in each case averaged over multiple inference runs, wherein the averaged activation differentials are in each case provided and taken into account when changes are made. In particular, it is possible to average over the inference runs of changed training data which has been changed using different manipulation methods. As a result, the robustness may be assessed averaged over the individual manipulation methods and taken into account when changes are made. For example, to this end, an expected value is determined for the activation differentials determined in each case on the basis of the changed training data (i.e., for a single neuron or for averaged regions).

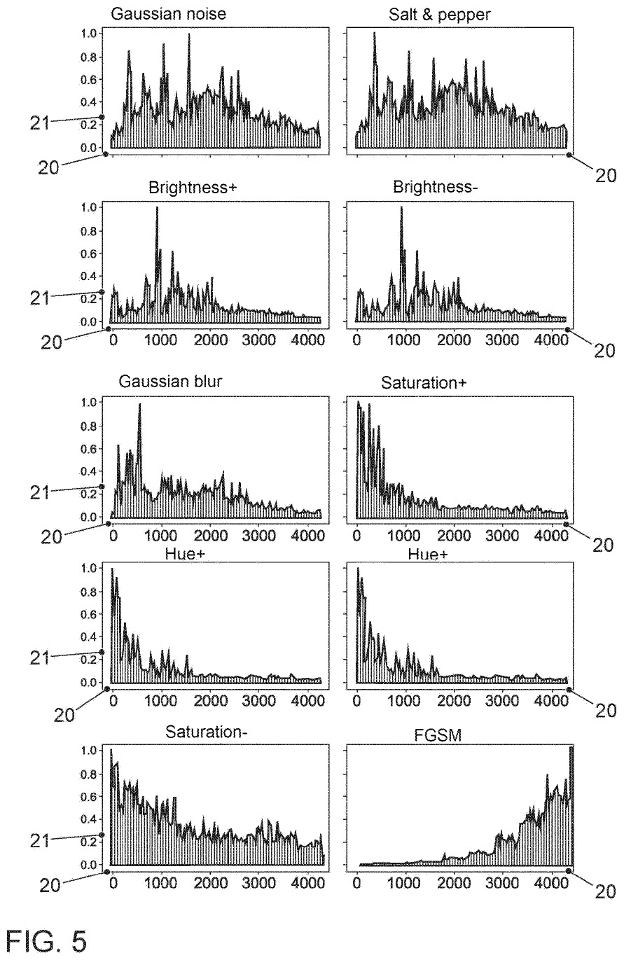

It may further be provided in method steps 102 and 103 that determined activation differentials are in each case provided and taken into account according to an associated manipulation method. This is represented, by way of example, in FIG. 5 which shows activation differences for individual filters of a convolutional neural network, which are determined for various manipulation methods according to the metric indicated above, wherein the x-axis 20 shows the index i of the filters in the convolutional neural network and the y-axis 21 shows an activation differential normalized for the maximum activation differential. It may be clearly seen that the activation differentials for various manipulation methods relate to different regions of the neural network configured as a convolutional neural network. Thus, for example, adding noise (FIG. 5: “Gaussian noise” and “salt & pepper”) affects almost all of the filters more or less equally. On the other hand, particularly the filters having a small index (i<1000) react sensitively to an increase in the color saturation (“saturation+”). Conversely, particularly the filters having a large index (i>3000) react sensitively to an adversarial attack by means of the “Fast Gradient Sign Method” (“FGSM”).

In some embodiments, it may be provided that the determined activation differentials are provided in a weighted manner according to a respective associated manipulation method and are taken into account when changes are made in method step 103. In the example shown in FIG. 5, the individual activation differentials would be multiplied by a weighting coefficient according to the respective associated manipulation method, and the products would subsequently be added up for the individual filters. The result may be represented graphically in the same way and shows a sensitivity of the neural network averaged over the manipulation methods used. As a result, the change may take place in method step 103 according to the activation differentials averaged over multiple manipulation methods, so that a robustness of the neural network may on average be increased with respect to all of the manipulation methods under consideration.

It may also be provided that neurons and/or regions of the neural network are sorted according to the activation differentials determined in each case for these, and an associated ranking is provided. For example, the activation differentials shown in FIGS. 4 and 5 and provided with an index i of the filters may be sorted according to their respective height, and a ranking corresponding to the sorting may be formed. A number of the filters having the greatest activation differentials may subsequently be identified.

Rectified Sheet (Rule 91) Isa/Ep

When the parameters and/or the architecture or structure of the neural network is/are subsequently changed in method step 103, it may then be provided, for example, that merely the top 5% or 10% of the most sensitive neurons or regions are changed, but the remaining neural network is left unchanged. As a result, an optimization or an increase in robustness may take place in a more targeted and efficient manner.

### LIST OF REFERENCE NUMERALS

1 Neural network
2 Training data set
3 Manipulation method
4 Changed training data set
5 Activation
6 Differential formation step
7 Activation differential
8 Change step
9 Robustness measure
10 Changed neural network
11 Training step
12 Trained changed neural network
13 Termination criterion
20 X-axis (filter index)
21 Y-axis (normalized activation differential)
30 Device
31 Means
32 Computing apparatus
33 Memory
100-106 Method steps

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “serving as an example, instance, or exemplification”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for improving robustness of a neural network in a function-specific manner, comprising:
the neural network, wherein the neural network is trained on the basis of a training data set including training data;
generating at least one changed training data set by manipulating the training data set, wherein the training data is changed while maintaining semantically meaningful content;
changing one or more of parameters and an architecture of the neural network according to a comparison result of a comparison between an application of the original training data set and the at least one changed training data set on the trained neural network;
training the changed neural network on the basis of the training data set and at least one part of the at least one changed training data set.

2. The method of claim 1, wherein changing one or more of the parameters and the architecture of the neutral network and training the charged neutral network are repeated until at least one termination criterion is met.

3. The method of claim 1, wherein a robustness measure is determined for the neural network on the basis of the comparison, wherein the changing is conducted on the basis of the determined robustness measure.

4. The method of claim 3, wherein the termination criterion is a convergence of the determined robustness measure.

5. The method of claim 4, the termination criterion is one of more of reaching a target value for a functional quality of the trained changed neural network and reaching a target value for the determined robustness measure.

6. The method of claim 1, wherein changing one or more of the parameters and of the architecture is made separately by one or more of neurons and regions.

7. The method of claim 1, wherein upon comparison at least one activation differential between an activation of the neural network via the training data of the original training data set and an activation via the respective corresponding training data of the at least one changed training data set is determined, wherein the change is made on the basis of the determined at least one activation differential.

8. The method of claim 7, wherein activation differentials are determined and taken into account by neurons and/or regions.

9. The method of claim 8, wherein determined activation differentials are in each case taken into account averaged over multiple neurons and/or over a region.

10. The method of claim 7, wherein determined activation differentials are taken into account in a weighted manner according to a position of an associated neuron layer within the neural network.

11. The method of claim 7, wherein determined activation differentials are in each case taken into account averaged over multiple inference runs.

12. The method of claim 7, wherein determined activation differentials are in each case taken into account in a weighted manner according to an associated manipulation method.

13. The method of claim 7, wherein neurons and/or regions of the neural network are sorted according to the activation differentials determined in each case for these, wherein changing is made on the basis of an associated ranking.

14. A device for improving robustness of a neural network in a function-specific manner,
access the neural network, wherein the neural network is trained on the basis of a training data set including training data;
generate at lease one changed training data set by manipulating the training date set, wherein the training data is changed while maintaining semantically meaningful content;
change one or more of parameter a and an architecture of the neural network according to a comparison result of: a comparison between an application of the original training data set and the at least one changed, training data set on the trained neural network; and
train the changed neural network on the basic of the training data set and at least one part of the at least one changed training data set.

15. (canceled)

16. A non-transitory computer-readable storage medium comprising commands which, when run by a computer, prompt the latter to:
access the neural network, wherein the neural network is trained on the basis of a training data set including training data;
generate at least one changed training data set by manipulating the training data set, wherein the training data is changed while maintaining semantically meaningful content;
change one or more or parameters and an architecture of the neural network according to a companion result of a comparison between an application of the original training data set and the at least one changed training data set on the trainee neural network; and
train the changed neural network on the basis of the training data set and at least one part of the at least one changed training data set.

17. The method of claim 2, wherein a robustness measure is determined for the neural network on the basis of the comparison, wherein the changing is conducted on the basis of the determined robustness measure.

18. The method of claim 17, wherein the termination criterion is a convergence of the determined robustness measure.

19. The method of claim 3, wherein the termination criterion is one or more of reaching a target value for a functional quality of the trained changed neural network and reaching a target value for the determined robustness measure.

20. The method of claim 4, wherein the termination criterion is one or more of reaching a target value for a functional quality of the trained changed neural network and reaching a target value for the determined robustness measure.

21. The method of claim 2, wherein changing one or more of the parameters and of the architecture is made separately by one or more of neurons and regions.
